(19) United States
(12) Patent Application Publication
(10) Pub. No.: US 2014/0026817 A1
(43) Pub. Date: Jan. 30, 2014

(54) Sure Feed Bird Feeder

(71) Applicant: Richard Jess Diaz, Merced, CA (US)

(72) Inventor: Richard Jess Diaz, Merced, CA (US)

(21) Appl. No.: 13/485,180

(22) Filed: Jul. 26, 2012

(51) Int. Cl. A01K 39/014

(52) U.S. Cl. CPC A01K 39/014
USPC 119/52.2

(57) ABSTRACT

The Sure Feed Bird Feeder would consist of an upper feeder and would be filled with bird feed by means of a removable top. The middle of the unit would feature a funnel bowel, while the bottom of the unit would feature a collection tray.

To use the Sure Feed Bird Feeder, the owner would simply hang it or pole-mount it in any desired location. The birds would feed from the top of the unit, and any scattered feed would be caught by the funnel and deposited into the bottom collection tray to be recycled. Once in place, this using would prevent scattered seed from falling to the ground causing unnecessary waste and would extend the longevity of the owners purchased feed.

### BACKGROUND

### Prior Art

| Pat. No. | Patentee | Issue Date |
|---|---|---|
| 4,896,628 | Kadunce | 30 Jan 1990 |

In the past many bird enthusiast have used many different types of feeders; most commonly are those that are filled by the owner. There are also some which use vertically stacked designs with disposable feed containers—for example U.S. Pat. No. 4,896,628. Although these are convenient ways to fill the feed containers, they do not eliminate the excessive waste produced by the animals while they are feeding. Birds will toss seed around while eating from a bird feeder, whether or not there are viable seeds within the shells. This waste is not only expensive to the owner of the feeder, but it will also implant itself into the soil below causing unwanted greenery, which can become troublesome to remove.

Although Kadunce's animal feeder established a means to fill feeders with disposable feed cylinder pre filled with feed, there is no means to address this waste. Also, by using a disposable feeding cylinder owners are introduced to a higher cost when compared to alternative options such as buying by the bag all while introducing additional products into landfills when disposing of the used feed containers.

### SUMMARY

The Sure Feed Bird Feeder will allow enthusiasts to lower costs for their feed by reducing the amount of waste while allowing them the ability to use the lowest cost source of the feed itself.

### DRAWINGS

Figures

FIG. 1 is a view from the bottom of the feeder.

FIG. 2 is an itemized view of the feeder.

FIG. 3 is an eye level view of the feeder.

FIG. 4 is an eye level view of the feeder from the rear.

FIG. 5 is an eye level view of the feeder in its disassembled state.

Drawings - Reference Numerals

| | |
|---|---|
| 1 | cap covering the feed opening |
| 2 | hanging device |
| 3 | upper refillable feed container |
| 4 | feed opening |
| 5 | perch for bird |
| 6 | braces attached to funnel catch |
| 7 | funnel catch |
| 8 | lower cylinder cap |
| 9 | lower cylinder |
| 10 | lower feed opening |
| 11 | lower perch |
| 12 | lower feed tray |
| 13 | liquid drain screen |
| 14 | mounting bracket |
| 15 | screw |

### DETAILED DESCRIPTION

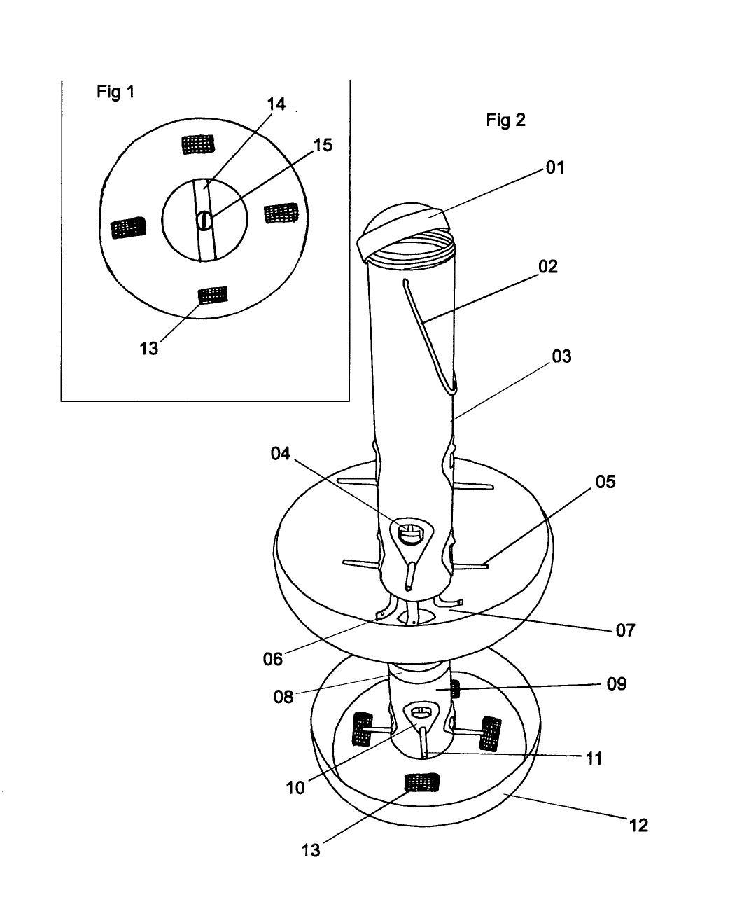

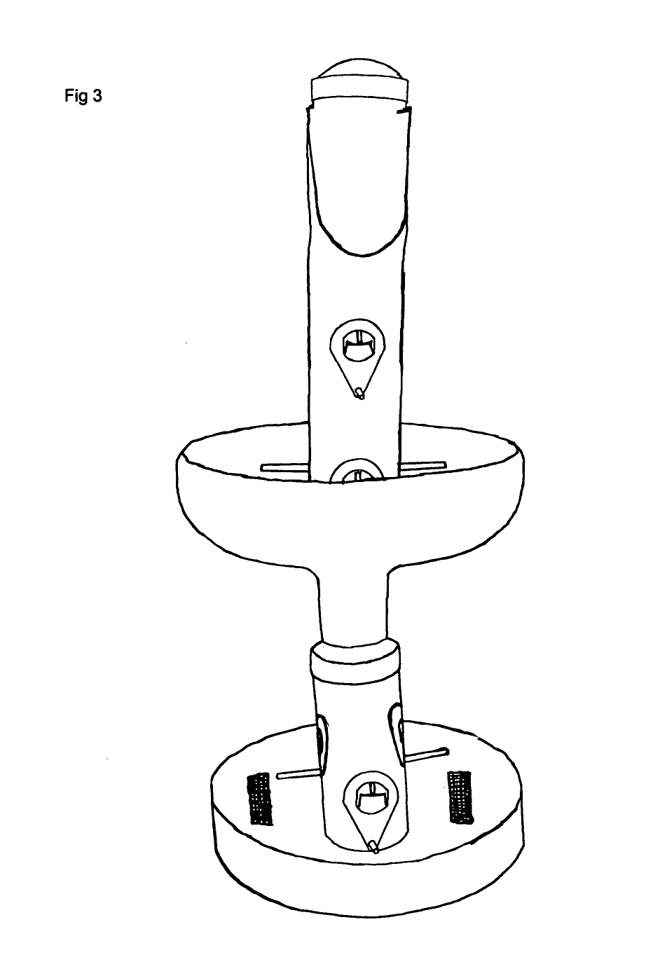

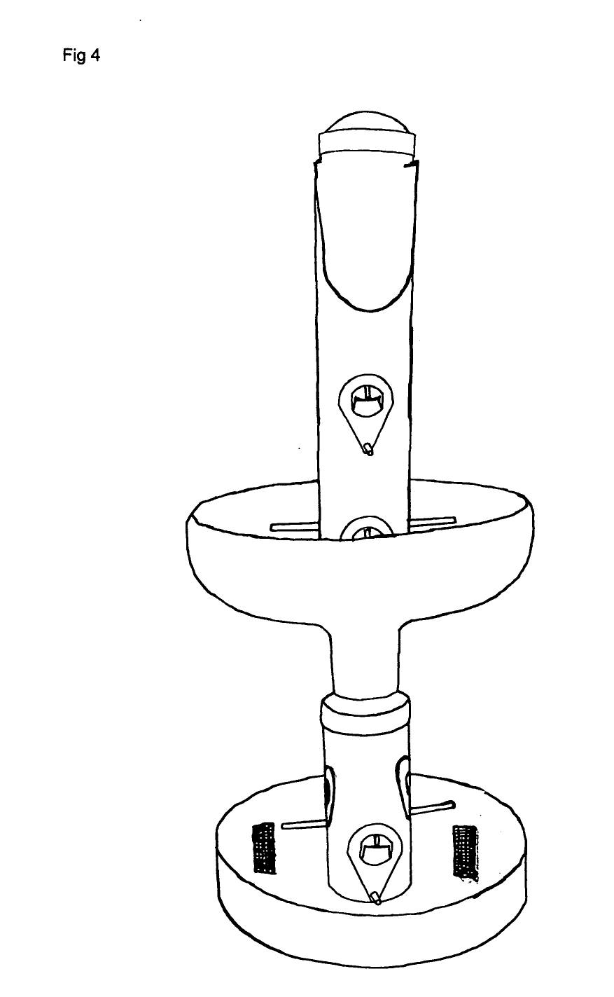

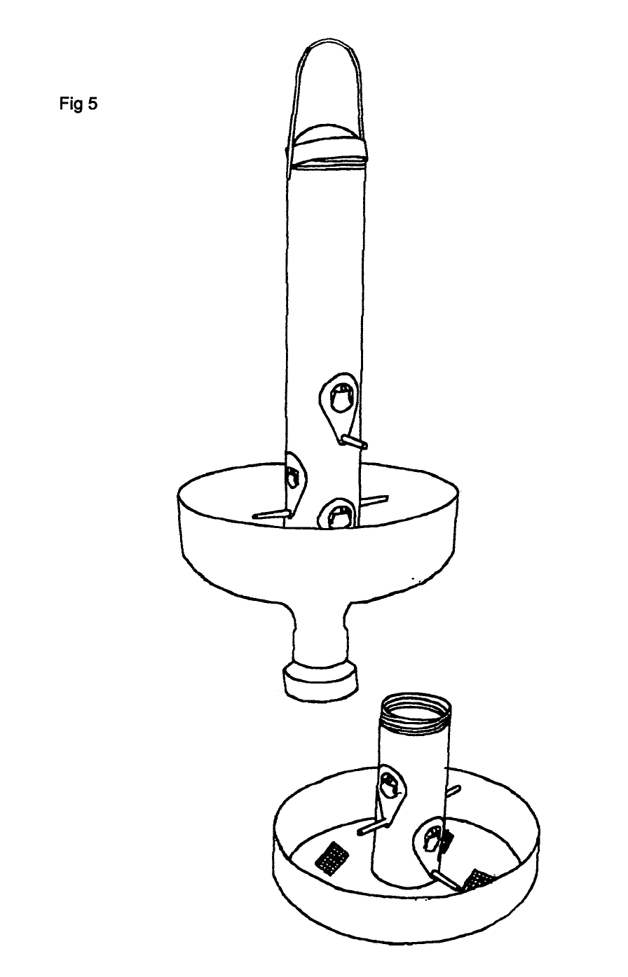

FIGS. 1 and 2

01 is attached to the upper feeding cylinder 03. A hanging device 02 supports the feeder. There are modular feeding openings 04 on the upper cylinder, each with a perch 05 attached. The upper cylinder is then attached to a funnel 07 by means of four braces 06.

The funnel 07 is mounted to a second cylinder 09 by means of a screw on cap 08. The lower cylinder contains additional feeding openings 10, each with a perch attached 11. The cylinder is then connected to a lower feed tray 12 by means of a mounting bracket 14 and screw 15. The lower tray has liquid draining screens 13.

1. Sure Feed Bird Feeder assembly comprising
a feed container having an opening through which feed may be introduced into the container,
and a funnel integrated into the assembly, which may be mounted so as to register with the opening to facilitate filling the container with feed, said funnel being integrated into the assembly when the feeder is in the feeding configuration in the position which is in the same position of the funnel when it registers with the opening.

2. A Sure Feed Bird Feeder assembly as defined in claim 1 wherein the opening is at the top of the container when the feeder is in its configuration.

3. A Sure Feed Bird Feeder assembly comprising
A feed container having an opening through which feed may be introduced into the container, the opening being the top of the container when the feeder is in its feeding configuration, and a funnel integrated into the assembly, which may be mounted so as to register with the opening to facilitate filling the container with feed.

4. A Sure Feed Bird Feeder assembly as defined in claim 1 where in the funnel is integrated as a cover into the assembly when the feeder is in its feeding configuration.

5. A Sure Feed Bird Feeder assembly comprising
a feed container having top and bottom ends with at least one end being open end.
A cover having a top portion and detachably secured to the end of the container and being funnel shaped and capable of functioning as a funnel when inverted.
Said cover including a discharge spout at the top portion and sized to fit into the open of the container whereby the cover when inverted may registrar with the open end when the container is positioned with its open end up on top to facilitate pouring feed into the container.

6. Sure Feed Bird Feeder as defined in claim 5 wherein
The open end of the container is the top end when the container is in the container is the top normal bird feeding position.

7. A Bird Feeder as defined in claim 5 wherein the open end of the container is the bottom end thereof when the container is in the normal bird feeding position.

8. A Bird Feeder as defined in claim 5 wherein A cap is provided to cover and close
Claim 2 a changing devise to support the Sure Feed Bird Feeder
Claim 3 Bird seed chamber where the feed in held in
Claim 4 there are 6 modular where the birds feed from in the upper portion of the funnel
Claim 5 there are 6 perches for the birds to feed from on the upper portion of the funnel
Claim 6 there are 4 rivets on the upper portion of the funnel that's the funnel where in the base in secure to the bottom of the base.
Also additional 4 rivets that are connected to the bottom portion of the lower container where it is secure to the base.
Claim 7 is the funnel where it gathers the discarded bird feed which drops the bird feed in to the lower feeder.
Claim 8 is a cap that is attached to the upper portion of the feeder as well as the lower feeder, which will allow you to detach the bottom feeder to clean it.
Claim 9 Lower feeder chambers that collects the discarded bird feed for the birds which is gather from the funnel.
Claim 10 there are 4 modular where the birds feed from in the upper portion of the funnel
Claim 11 there are 4 bird perches on the lower portion of the funnel for the birds to collect the bird feed.
Claim 12 is the tray which gathers the empty shells from the bird feed
Claim 13 there are 4 water drains which allows condensation to drain out
Claim 14 is bracket that connects to the tray of the lower feeder
Claim 15 is a screw that holds both the upper and lower funnel together
